(19) United States
(12) Patent Application Publication
(10) Pub. No.: US 2007/0214125 A1
(43) Pub. Date: Sep. 13, 2007

(54) Method for identifying a meaning of a word capable of identifying a plurality of meanings

(76) Inventor: Frank John Williams, Los Alamitos, CA (US)

Correspondence Address: Frank John Williams, 2711 Saint Albans Dr, Los Alamitos, CA, 90720, US

(21) Appl. No.: 11/716,315

(22) Filed: Mar. 8, 2007

Related U.S. Application Data
(60) Provisional application No. 60/780,743, filed on Mar. 9, 2006.
(60) Provisional application No. 60/782,893, filed on Mar. 16, 2006.
(60) Provisional application No. 60/783,476, filed on Mar. 18, 2006.

(51) Int. Cl. G06F 17/30

(52) U.S. Cl. 707/3

(57) ABSTRACT

A method and system for identifying in a corpus of data an M number of concepts of a first word capable of identifying an N number of concepts, wherein N is greater than M. The method comprises of identifying a second word in the corpus of data which is associated to the first word by a corresponding M number of concepts for identifying the M number of concepts of the first word for at least one of a: searching, retrieving and registering of information. Furthermore, the method implements several data corpuses for increasing its information databases for identifying information.

### RELATED APPLICATIONS

This is application claims the benefit of: U.S. provisional patent application Ser. No. 60/780,743, filed 2006 Mar. 8, U.S. provisional patent application Ser. No. 60/782,893 filed 2006 Mar. 16 and U.S. provisional patent application Ser. No. 60/783,476 filed 2006 Mar. 18 by the present inventor.

### BACKGROUND

1. Field of the Invention

The present invention relates generally to a method for identifying information for searching and storing. More specifically, to a novel method for identifying a meaning of a word that has several meanings implementing other words in the neighboring corpus of information.

2. Description of Related Art

Because the revolution of the Internet and its massive quantities of information, more and more people use search engines everyday to find what is important to them. However, in any particular language, words can have several meanings, or eventually adopt additional ones. For example, the word “dog” identifies an animal, but also can identify a tool, and a despicable person to name just a few. In addition, the ratio of interaction between different cultures with different languages increases more day by day, developing a growing necessity for search engines to better identify the proper concept and/or meaning of a word(s), to reduce the time people spend looking for information, while avoiding irrelevance.

In view of the present growing needs and shortcomings, the present invention distinguishes over the prior art by providing heretofore a method to allow information searching and storing entities, such as search engines to quickly and effectively identify the concept a word or group of words has, wherein said word or group of words identifies several meanings or concepts. In addition, the method provides additional unknown, unsolved and unrecognized advantages as described in the following summary.

### SUMMARY OF THE INVENTION

The present invention teaches certain benefits in use and construction which give rise to the objectives and advantages described below. The methods and systems embodied by the present invention overcome the limitations and shortcomings encountered when searching, storing or identifying information comprising words identifying several meanings. The method permits to quickly and effectively, select or identify one of the meanings or concepts of a said word in a corpus of information, by implementing the concept(s) or meaning(s) of other words in its immediate or neighboring area.

### OBJECTS AND ADVANTAGES

A primary objective inherent in the above described method of use is to provide a method for identifying concepts of words for searching, retrieving and/or storing information not taught by the prior arts and further advantages and objectives not taught by the prior art. Accordingly, additional objectives and advantages of the invention are:

Another objective is to aid search and storage information entities, such as search engines, to quickly and effectively identify the concept of a word with multiple concepts in a corpus of information;

A further objective is to decrease or reduce the time required for identifying a concept of a multiple conceptual word.

A further objective is to automate the word's concept identifying process;

A further objective is to reduce irrelevant data retrieved by a search engine.

A further objective is to reduce the time needed for a client to find relevant information in a search engine results data or other corpus of data.

A further objective is to amplify the cognitive ramifications and associations of human knowledge.

A further objective is to permit the retrieval of information from several languages.

A further objective is to recognize and/or dismiss connotative functions of any particular word.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate examples of at least one of the best mode embodiments of the present method of use. In such drawings:

FIG. 1 illustrates a non-limiting block diagram of the basic steps of the inventive method;

FIG. 2 illustrates an example using words illustrating the basic identifying steps of the inventive method for later producing search results or for modifying data for searching;

FIG. 3 illustrates a non-limiting more detailed example of the inventive method discovering the concept of a particular word such as “dog” in several corpuses of data;

FIG. 4 is a non-limiting flow chart of the inventive method producing searched results;

FIG. 5 is a variation non-limiting flow chart of the inventive method producing search results modified by a user;

FIG. 6 is an exemplary flow chart of the inventive method modifying a data corpus for identifying its concepts;

FIG. 7 is an illustration of the inventive method operating on identifiers such as information identifying a group of words;

FIG. 8 is a flow chart of inventive method scaling information for discovering concepts of a corpus of data;

FIG. 9 is an illustration of the inventive method increasing its information databases by operating on additional data corpuses while suggesting self teaching, self discovering, self analysis and self training of a system.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

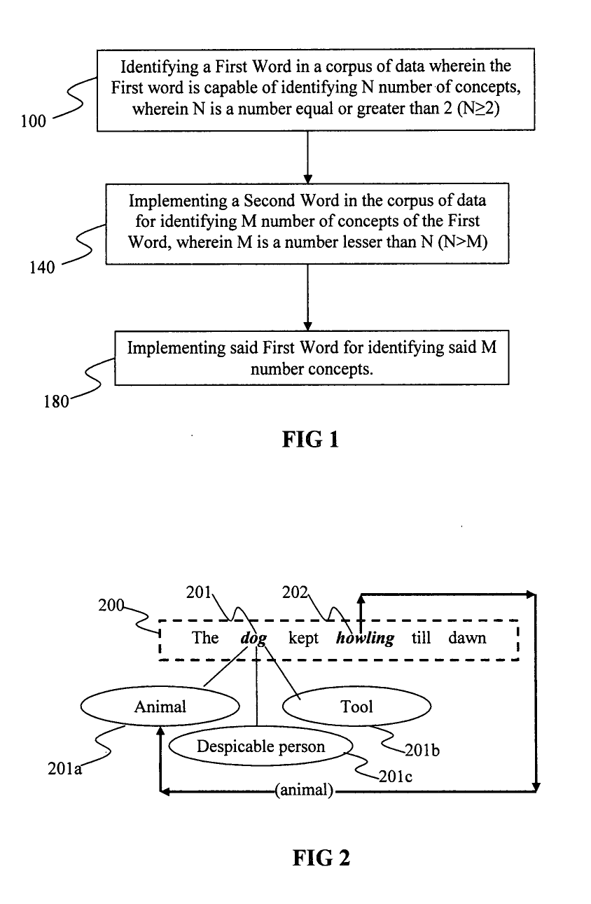

FIG. 1 shows a non-limiting block diagram of the basics of the method of the invention. This disclosure describes a method for identifying a concept of a word, wherein said word has the capability to identify several concepts for the purpose of searching, retrieving and/or storing the identified information by implementing the concept or meanings or neighboring words in a particular corpus of information. The first step of the basic method 100 (FIG. 1) implies identifying a first word that is used to identify several concepts (or has several meanings). For example, the text “dog” can be used to describe several concepts such as an animal (canis familiaris), a despicable person, a slovenly woman, a tool, etc. In the second step of the method 140 (FIG. 1), a second word (or more) in the neighboring area which identifies a single (or lesser number) concept is selected to be used or aid in the identification of a single (or more) concept of the first word capable of identifying several concepts. For example, in the phrase “the dog barked,” the first word “dog” can adopt several meanings as described before. Yet selecting the second word “barked” can be used for deducting or finding the concept implied by the first word “dog.” The third step 180 (FIG. 1) of the basic method is to implement the second word for identifying a single concept or more but lesser than the number of all the concepts that the first word can assume. For example, the second word “barked” from the phrase “the dog barked” is now used to identify that the concept of the first word “dog” in the corpus of data or phrase which is that of the domestic animal.

FIG. 2 illustrates a non-limiting example of a corpus of data 200 (FIG. 2) comprising the sentence “the dog kept howling till dawn.” The word “dog” 201 (FIG. 2) is capable of identifying a plurality of concepts such as: an animal 201a (FIG. 2), a despicable person 201b (FIG. 2), and a “tool” 201c (FIG. 2). By selecting the word “howling” 202 (FIG. 2) the actual concept of the word “dog” 201 (FIG. 2) can be identified in the sentence; which is this examples happens to be that of the animal 201a (FIG. 2).

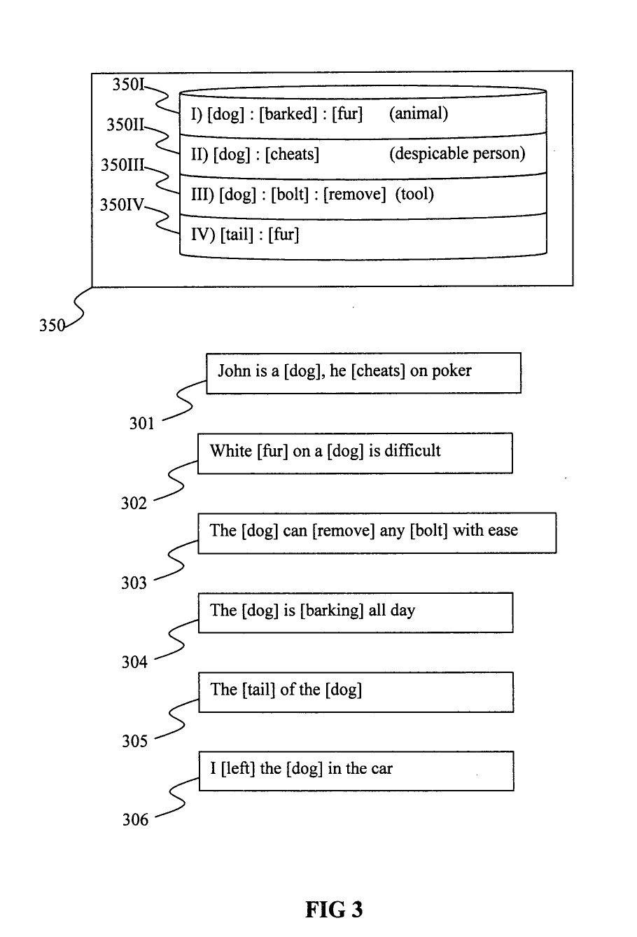

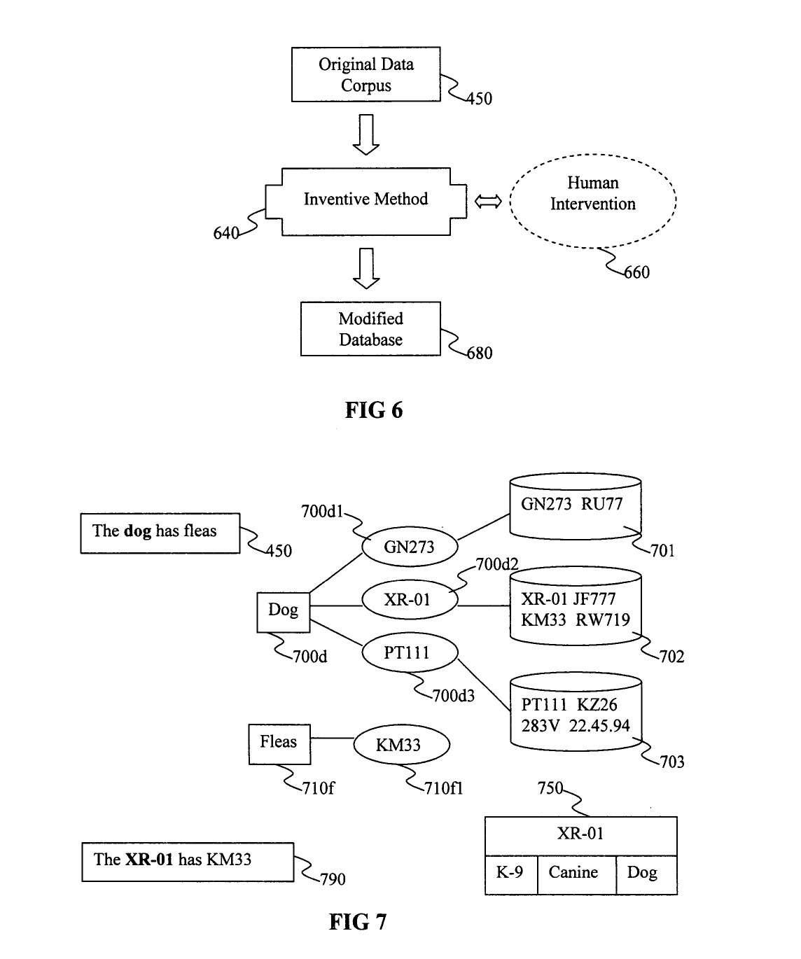

FIG. 3 illustrates a non-limiting example of an identifying database 350 (FIG. 3) which is used for identifying a particular concept [dog] of the word by associating the said word [dog] with other words pertinent to each of the concepts [dog] can assume. Noteworthy, in order to simplify this disclosure, only three meanings or concepts of the word [dog] will be contemplated. In addition, the database contains a description of the meaning the word [dog] has under each group of words. For example, in the first record or association 350.1 (FIG. 3) the word [dog] is associated to the words [barking] and [fur] all of which are pertinent to the animal concept. In the second association 350.II (FIG. 3), the word [dog] is this time associated to the word [bad] for its secondary concept of a “despicable person.” In the third association 350.III (FIG. 3), the word [dog] is associated to the word [bolt] and the word [remove], for identifying its third and final concept of a “tool.” The fourth association 350.IV (FIG. 3), relates the word [tail] with the word [fur]. The data corpuses 301-307 (FIG. 3) will be compared to the identifying database 350 (FIG. 3) for determining or discovering the concept the word [dog] has in each of the data corpuses. For example, in the first data corpus 301 (FIG. 3) the word [dog] is next or near to the word [bad]. According to the identifying database 350 (FIG. 3), the second record teaches that when [dog] in spatial relationship with [bad], the concept of [dog] is that of a despicable person, therefore implying that the concept of [dog] in the first data corpus 310 (FIG. 3) is that of a despicable person. The second data corpus 302 (FIG. 3) comprises a sentence wherein the word [dog] is in spatial relationship with the word [fur]; which according to the first association 350I (FIG. 3) of the identifying database 350 (FIG. 3) implies that concept for [dog] is that of the animal. In the third sentence or data corpus 303 (FIG. 3), the word [dog] is close or near the word [remove] and the word [bolt]; which once again, according to the database's third record 350.III (FIG. 3) when the words [dog] and [remove] and further [bolt] are neighbors, then the concept is that of a “tool.” As a matter of fact, it may be assumed that the concept is undeniably correct since the number a valid associations equals and/or surpasses a particular limit or value. The forth data corpus 304 (FIG. 3) comprises the words [dog] and [barking], which according to the first record 350I (FIG. 3) of the database implies that [dog] is used to describe the animal. The fifth data corpus 305 (FIG. 3) contains the words [dog] and [tail]. According to the database 350 (FIG. 3) there is no direct association for using [tail] or any other word for identifying the concept of the word [dog]. However, in the fourth association 3501V (FIG. 3) of the database, the word [tail] is associated to the word [fur] which fortunately, the word [fur] is also associated in the first record 3501 (FIG. 3) to the word [dog]; therefore it can be deduced that [tail] and [dog] associated even in a second level (for purpose of this disclosure) therefore concluding that the concept of [dog] in the data corpus 305 (FIG. 5) is that of the animal. The sixth data corpus 306 (FIG. 3) contains the word [dog] and the word [left] which unfortunately isn't in the database 350 (FIG. 3). No primary, or secondary, or any other type of associations exists to determine the concept of [dog] in such data corpus 306 (FIG. 3). As a consequence, the word [dog] in the sixth data corpus 306 (FIG. 6) is identified as an unidentified word or has an unidentified concept. Optionally, the multi-conceptual words with unidentified concepts can be separated, grouped or managed differently such as providing the unidentified results to a human for identification.

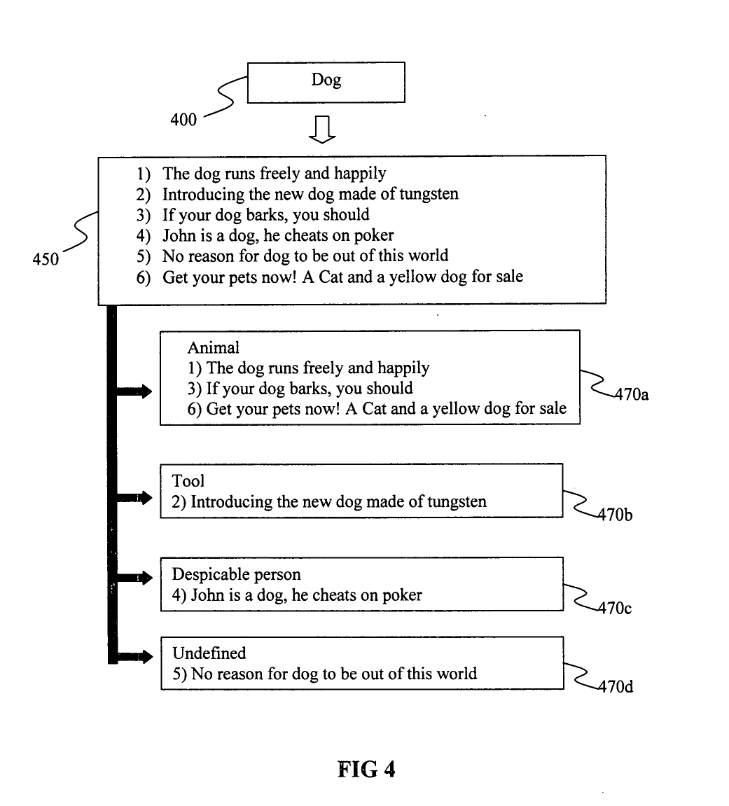

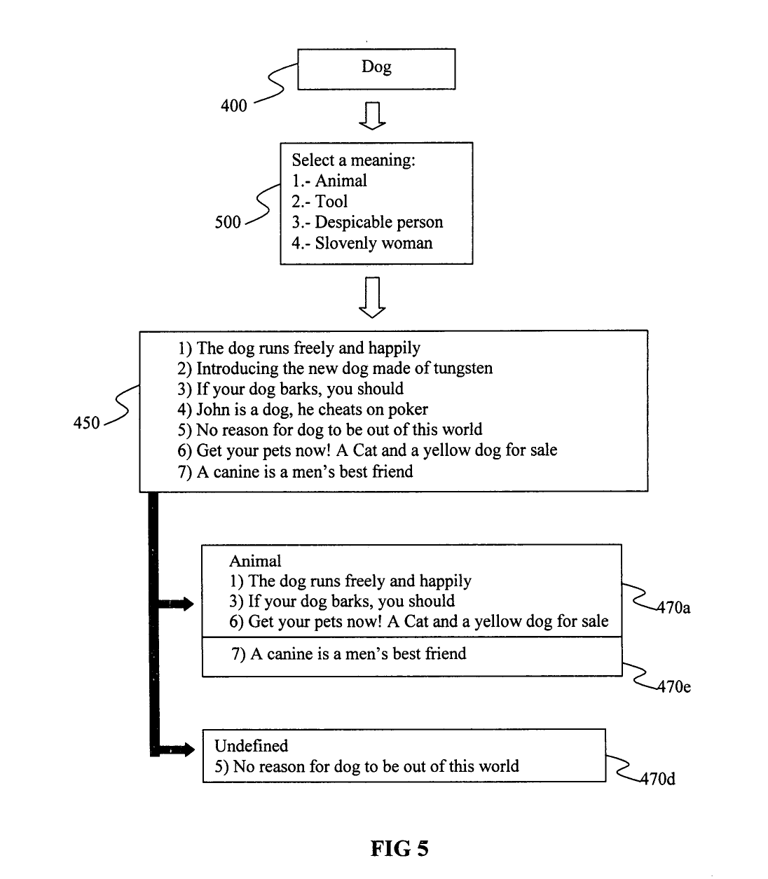

FIG. 4 illustrates a query 400 (FIG. 4) of [dog] over a data corpus 450 (FIG. 4) for searching of finding information; which produced four groups of results 470a-470d (FIG. 4). As a matter of fact, in each of the groups are the results which comprise each of the meanings of the word “dog.” For example, in the first group 470a (FIG. 4), all the records wherein the query or word “dog” identifies the domestic animal are illustrated together. Just below is the second group of results 470b (FIG. 4) wherein the word “dog” is now used to identify a tool. Next is the record(s) 470c (FIG. 4) wherein the third concept of the word “dog” is used. This time the concept related to a despicable person. Finally, in the last part 470d (FIG. 4) the records wherein it was not possible to identify the meaning for word in the query “dog” are illustrated.

FIG. 5 illustrates a variation of the results generated when a user specifies or selects a concept of a multi-conceptual word in a query such as the word “dog.” The query 400 (FIG. 5) produces a selection 500 (FIG. 5) for a user to select a concept. In this example, the user chooses the meaning of an animal. The data corpus for providing information 450 (FIG. 5) is then searched producing the results below 470a (FIG. 5) wherein the word “dog” is indeed used to describe an animal, such as “the dog runs freely and happily,”“if your dog barks you should,” and “get your pets now! A cat and a yellow dog for sale.” FIG. 5 also illustrates a synonym record 470e (FIG. 5) under or within the “animal” concept group such as “a canine is a men's best friend.” Also illustrated is the optional “Undefined” group 470d (FIG. 5) wherein this time those records in which the concept for the word “dog” can not be defined or has not being defined yet such as “no reason for dog to be out of this world.” Please note that additional information to identify the concept could be added, additional information already identifying the concept could be used, or even the scope as to how many words could be included before declaring an undefined concept for a multi-conceptual word could be considered. The next figure intends to cover such a series of operations.

FIG. 6 illustrates an original data corpus 450 (FIG. 6) or information containing multi-conceptual words wherein the identification of their meanings has not been discovered. The next step illustrates the disclosed basic inventive method 640 (FIG. 6) for modifying the original corpus data 450 (FIG. 6). The next step involves registering the modifications of the information of the original data corpus 450 (FIG. 6). Also illustrated is the optional and/or additional method of implementing a human 660 (FIG. 6) to assist in the identification effort of hopefully a single concept or use a human for identifying hopefully a single concept.

FIG. 7 illustrates a further example of the inventive method this time implementing identifiers. In the data corpus 450 (FIG. 7) the concept(s) of the multi-conceptual word “dog” has not yet being identified. In fact, in this example the word “dog” 700d (FIG. 7) has three identifiers such as the GN273 identifier 700d1 (FIG. 7), the XR-01 identifier 700d2 (FIG. 7), and the PT111 identifier 700d3 (FIG. 7). Each of the identifiers has its own identifying database 701-703 (FIG. 7). Also in FIG. 7 the word “Fleas” 710f (FIG. 7) is illustrated having an identifier of KM33 710f1 (FIG. 7) wherein for the purpose of this example, it has a single meaning. The optional table 750 (FIG. 7) is served to illustrate that the XR-01 identifier can be used to identify several synonyms such as “dog,” “k-9,” and “canine.” Returning our view to the data corpus 450 (FIG. 7) and the word “dog” 700d (FIG. 7) it is obvious that the word “dog” can assume either of the its identifiers. However, in the database 702 (FIG. 7) of the XR-01 identifier 700d2 (FIG. 7) the KM33 identifier co-exists with an XR-01 identifier and no place else. Therefore, the XR-01 identifier 700d2 (FIG. 7) is indeed the correct identifier for the word “dog” of the data corpus 450 (FIG. 7). As a result, the data corpus 450 (FIG. 7) can be modify to contain the correct identifiers or be replaced as shown by the modified data corpus 790 (FIG. 7). Please note that for purpose of this example, the words “the” and “has” in the original data corpus 450 (FIG. 7) and modified data corpus 790 (FIG. 7) have being omitted or ignored to simplify this disclosure.

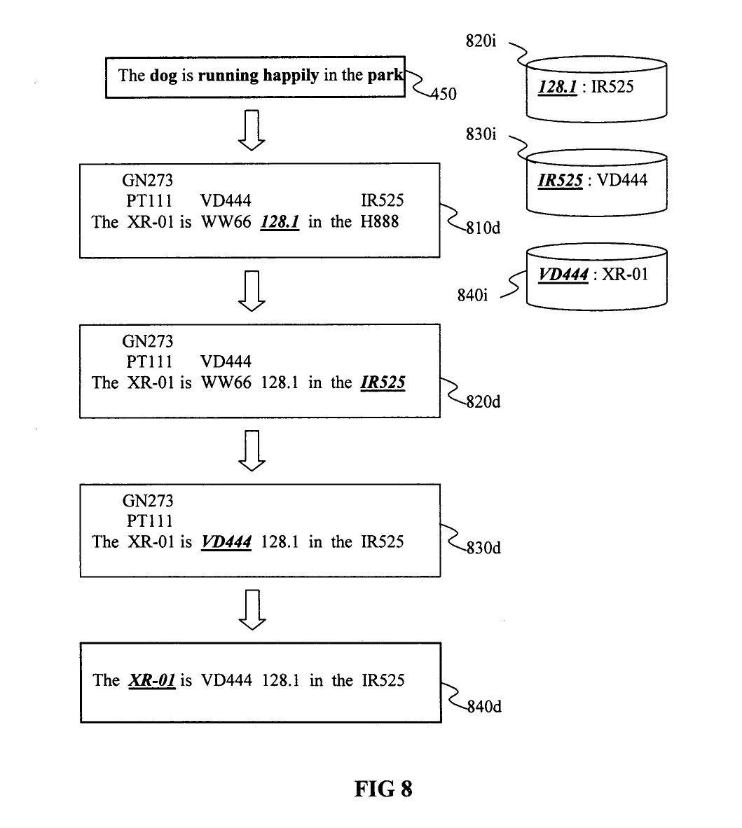

FIG. 8 illustrates a further method of first implementing words and/or identifiers with the minimum number of concepts. For example, the original data corpus 450 (FIG. 8) is illustrated in the data corpus below 810d (FIG. 8) comprising several possible identifiers such as three identifiers for the word “dog,” two identifiers for the word “running,” a single identifier for the word “happily,” and finally two identifiers for the word “park.” Selecting the single identifier for the word “happily” and searching in the identifying databases 820i-840i (FIG. 8), it is found that in the first database (or section of database) the 128.1 identifier is associated to the IR525 identifier. As a result it can be concluded that the identifier IR525 is the correct assumption, thus producing the next data corpus 820d (FIG. 8). In similar fashion, the identifier IR525 is associated in the second identifying database 830i (FIG. 8) with the identifier VD444. As a result, the VD444 identifier is the correct assumption to re-modify the data corpus 820d (FIG. 8) once again to the data corpus one step below 830d (FIG. 8). Once again a search is executed trying to discover which identifier should be used to identify the word “dog.” In this example, it is the identifier VD444 which is found in the third identifying database 840i (FIG. 8) associated to the XR-01 identifier. As a final result, the previous data corpus 830d (FIG. 8) can be re-modified once more into the final data corpus 840d (FIG. 8) implementing the identifier XR-01 for identifying the last word “dog.” Please note, that words such as “the,”“is,” and “in the” were not included as to facilitated the demonstration. Please note also, that particular combinations such as that with articles, prefixes and other grammatical elements could have also being used to quickly identify the correct identifier and/or concept for the word. Furthermore, the frequency in which an identifier occurs in a particular language and/or the number of possible combinations permissible wherein a single word identifier did not exist as in the example (the word happily and its single identifier 128.1) can develop into a series of possibilities and statistics which ultimately can be analyzed by a human entity for suggestively making a final decision.

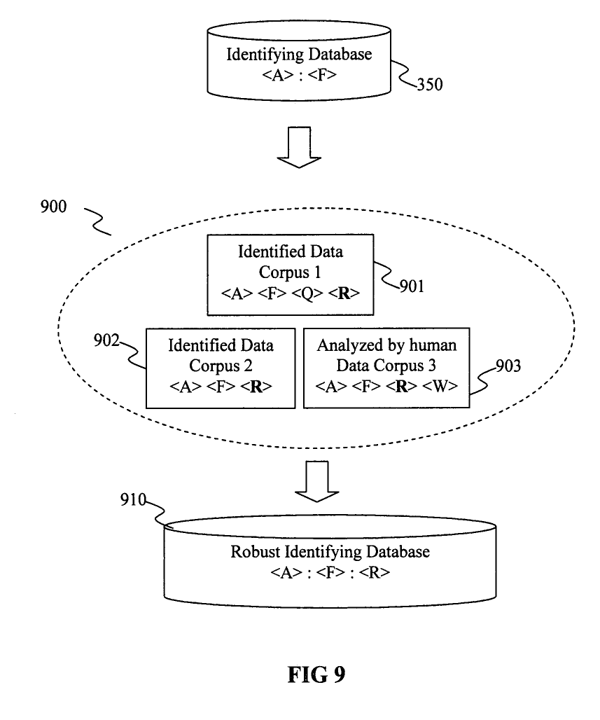

FIG. 9 illustrates a sample of implementing data corpuses of already analyzed data either by the method, a human and/or their combinations to increase, modified, fine tune or even created mathematical frequencies, existence analysis, and linguistic and or analytical laws, behaviors and exceptions of a particular language or group of languages. For example, in FIG. 9 an identifying database 350 (FIG. 9) is associating a word or identifier <A> with another single other word or identifier <F>. Then, already identified and/or analyzed group of records 900 (FIG. 9) including the records 901 (FIG. 9), 902 (FIG. 9) and 903 (FIG. 9) are implemented to increase the number of associations, thus creating a more robust identifying database 910 (FIG. 9). Please note that the first identifying data corpus 901 (FIG. 9) contains <A>, <F>, and <R>. The second identified record 902 (FIG. 9) also comprises the words or identifiers <A>, <F>and <R>. Furthermore, the data corpus analyzed by a human 903 (FIG. 9) also provides valuable information wherein <A>, <F>, and <R>are included. Therefore, the new more robust identifying database 910 (FIG. 9) can prospectively include the newer and more complete association of <A>: <F>: <R>. Please also note that a single identified data corpus or other could have been used. Please also note that for either case the <R>information identifying a word did not or could have not included any articles and/or other forms of grammatical elements that do not provide or posses any meaningful information for the method to operate. In another example, the identified records are analyzed, to see the frequency of a particular concept of a multi-conceptual word or its identifier for creating a statistical analysis inclusive in the new identifying database 910 (FIG. 9) for including aiding a human select a particular concept. Furthermore, the method can also be implemented for a system to self teach itself, including creating databases and/or other types of associations wherein the system does not necessary implies or utilizes the description or meaning of a word or information identifying a word, but rather its frequencies, possible and existing associations, including the position or flow of the information identifying the words. In addition, the system can create new identifiers when needed and/or suggestively for itself, another system or a human. In such fashion, the system can prospectively self train itself to even learn a different or new language including identifying all the associative and building rules of the language, with or without the aid or translation of dictionaries.

Noteworthy, the particular order of the steps of the disclosed inventive method(s) is of no particular relevance since many of these steps can occur simultaneously or in different sequences. Also, the query field can be originated from any type of information seeking entity such as a human, program, and machine. In similar manner, the ensuing results can be provided to either of such entities.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method(s) for identifying information for searching, retrieving and registering can be appreciated. The described method can aid to identify the meanings of multi-conceptual words specially contained in large data corpuses. In addition, the method(s) and system(s) provides organized results while prospective be implemented to discover new associations between word elements. Furthermore, the method(s) permit a system to identify word frequencies for further analyzing word interactions and suggestive associations for providing more robust search engines.

1. A method for identifying a meaning of a word wherein said word identifies a plurality of meanings, the method comprising the steps of:
a) Identifying a first information identifying a first word in a corpus of data, wherein said first word identifies an N number of concepts;
b) Identifying a second information identifying a second word in said corpus of data for identifying an M number of concepts, wherein N>M;
c) Assigning said M number of concept(s) of said second word to said first word.
